(19) United States
(12) Patent Application Publication
(10) Pub. No.: US 2003/0047022 A1
(43) Pub. Date: Mar. 13, 2003

(54) Adjustable pedal unit

(76) Inventors: Uwe Gohbrandt, Haan (DE); Ulrich Dipl.Ing Kizak, Niederwinkling (DE); Heinz-Walter Heinemann, Wuppertal (DE); Jurgen Weyreuter, Hengersberg (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/239,909

(22) PCT Filed: Apr. 5, 2001
(86) PCT No.: PCT/DE01/01365

(30) Foreign Application Priority Data
Apr. 10, 2000 (DE) 100 17 531.7

(51) Int. Cl. G05G 1/14

(52) U.S. Cl. 74/512

(57) ABSTRACT

The invention relates to a pedal unit, comprising a four-bar parallelogram. The pedal unit is made up of an upper retainer piece (8), a lower retainer bracket (11), with footplate (12) attached and two roughly parallel arms (9, 10), which are each rotatably mounted at one end on the upper retainer piece (8) and at the other end on the lower retainer bracket (12). The pedal unit may rotate about a main bearing (B). An adjuster device for the adjustment of the footplate (11), predominantly in the X-direction, is provided. The upper retainer piece (8) and a sliding block (5) are mounted on a guide pinion (6), in a displaceable and adjustable manner. A rod bearing (A) is arranged on the guide pinion (6), whereas the main bearing (B) is arranged on the sliding block (5) and a main bearing tie (3) and a rod bearing tie (4) are provided, one end of each being rotatably connected to a solid bearing block (1) and the other free end, rotatably mounted in the main bearing (B), or the rod bearing (A). A longitudinally adjustable strut (13) is mounted between the arms (9, 10), with both ends rotatably connected to the above arms.

The invention relates to a pedal mechanism according to the preamble of patent claim 1.

In order for it to be possible to adapt the operation of pedals, for example in a motor vehicle, to the different size of drivers and thus to the different position of the optimum force introduction point for the driver, a pedal mechanism must be adjustable in the direction of travel (X) and/or in height (Z). Adaptation of the pedals to different proportions and sitting habits of the drivers can thus also be carried out.

Solutions known in the prior art for adjustable pedal mechanisms make possible adjustment of the pedal virtually steplessly along a defined, usually curved path.

The pedal mechanism described in the introduction is known from JP 71 91 773. This mechanism has the disadvantage, however, that the adjustment in the X direction takes place on a circular path which is formed by the radius of the distance from the force introduction point to the main bearing, and that, moreover, the main bearing is fixed in its position by arrangement on a support which is stationary in relation to the body. Adjustment is effected by virtue of the spindle 64 driven by the actuating motor 66 attached to the web 36 pressing on the extended end of the lever 30, as a result of which the four-bar linkage rotates counterclockwise about the pivot bearing 40. This leads to the pushrod bearing 56 likewise being pivoted, clockwise, about the pivot bearing 40. The main bearing 16 is fixed, as the bearing shaft 16 is articulated on the stationary bearing block 14. A further disadvantage can be seen in the fact that there is no non-positive connection between the threaded rod 64 and the lever end 58. In this connection, moreover, only an adjustment essentially in the X direction is brought about, so that the points for the pressure point C which can be set by the adjustment lie along a pivoting movement carried out about the main bearing 16 with the radius L2a. The requirement of the automotive industry that the angular position of the pushrod may change by only a very narrowly dimensioned angular range on adjustment cannot be met by this arrangement.

From EP 0 936 527 A2, an adjustable pedal arrangement for motor cars is known, with an auxiliary lever which is mounted pivotably on a front shaft and is moved by a pedal lever which is mounted pivotably on a rear shaft arranged behind and below the front shaft. The auxiliary lever and the pedal lever are connected by an adjustable rod which is arranged essentially parallel to the plane in which the front shaft and the rear shaft lie. The auxiliary lever and the pedal lever form, with the adjustable rod, a parallelogram, that side of which formed by the rod is length-adjustable in order for it to be possible to modify the initial angular position of the footplate which is attached at the lower end of the pedal lever. Connected to the auxiliary lever is an operating rod for a brake or a clutch, which is moved by the forward movement of the footplate. In this way, the auxiliary lever, which moves the operating rod (pushrod), is moved by means of the pedal lever and the adjustable rod. Modification of the setting angle of the footplate makes possible greater variation of the footplate position without having to raise the arrangement in height of the footplate excessively, as the parallelogram arrangement keeps the pedal travel essentially unchanged.

A pedal mechanism described in the introduction is known from U.S. Pat. No. 3,151,499. In this pedal mechanism, the upper holding part, with an integrated pushrod bearing, is pivoted counterclockwise by a spring about the main bearing to come up against a stop fixed to the body. One of the levers, which is articulated by one end on the main bearing, can be pivoted counterclockwise by a length-adjustable spindle which is supported in relation to the body. In this way, the lower holding link, and with it the footplate, is, on a circular path, adjusted backward predominantly in the X direction and at the same time downward slightly in the Z direction. Independent height adjustment of the footplate in the Z direction is not possible with this pedal mechanism.

The technical problem underlying the invention consists in proposing a pedal mechanism, in which the footplate is adjustable in a range, which covers any point in a horizontal and vertical extent, and, in the case of a footplate setting which can be adapted to the force introduction angle, makes possible as horizontal as possible a movement path of the footplate on operation. This problem is solved by a pedal mechanism according to patent claim 1.

An illustrative embodiment, in which the adjusting device for the footplate is formed by a threaded rod which passes through nuts mounted by cardan means on both legs and has an oppositely directed thread in each case in the engagement region with the two nuts, has the advantage that it makes it possible in a simple manner to modify the four-bar parallelogram by strutting. In this way, adjustability of the footplate in or counter to the direction of travel (positive or negative X direction) is possible.

An illustrative embodiment with a threaded rod integrated in the guide rocker, which rod is in engagement with the upper holding part and the sliding block by means of oppositely directed threads, has the advantage that with it adjustment of the parts, holding part or sliding block, displaced in the vertical direction (Z direction) is made possible in a simple manner.

An illustrative embodiment, in which the ratio which the pitches of the right-hand thread and of the left-hand thread bear to one another is the transmission ratio, has the advantage that, by virtue of the different pitches, the modification of the distance between the pressure point and the main bearing can be converted into a corresponding modification of the distance between the main bearing and the pushrod bearing, so that the transmission ratio is retained on adjustment of the footplate also. In this way, it is advantageously guaranteed that, with the same force action on the footplate, the same output force is active on the pushrod bearing. The retention of the height position of the pushrod bearing makes it possible, moreover, for the angular position of the pushrod bearing to be retained advantageously virtually unchanged.

An illustrative embodiment, in which the upper holding part and the sliding block are interconnected via a cable pull and a deflection mechanism, constitutes an alternative for the compensation of the lever arm lengths corresponding to the transmission ratio. The design of the deflection mechanism in the manner of a pulley block constitutes a simple adaptation possibility for taking account of the transmission ratio.

If the rear leg in the X direction is slightly longer than the front leg, the holding link, and with it the footplate attached to it, is pivoted slightly counterclockwise on adjustment of the pedal in the −X direction, so that a movement coordinate pointing in the +Z direction is compensated and the footplate is adjusted on a virtually horizontal path.

An illustrative embodiment, in which the lengths of the two connecting rods are of corresponding size, the height position of the largely horizontal path, in which the line of action of the pressure point C runs on operation, can be lowered as required.

An embodiment, in which at least one of the threaded rods for the adjustment in the X direction and the Z direction is motor-driven, has the advantage that the adjustment can be introduced in a simple manner from the control panel by corresponding control signals.

The adjustability, according to the invention, of the pedal mechanism advantageously allows the attachment of the pedal mechanisms to be removed from the splashboard which is at risk of deformation in the event of a crash, and the attachment to be carried out to crash-independent cross struts instead.

An illustrative embodiment, in which an adjustable footrest is provided for the pedal mechanism, the adjustability of which is appropriately adapted to the position of the footplate, has the advantage that the driver will find an ergonomically favorable support possibility for the foot according to the adjustment of the footplate, so that unfavourable fatigue or cramp is avoided when the footplate is adjusted.

The advantages mentioned and other advantages are explained in the description of an illustrative embodiment shown in the accompanying drawing, in which

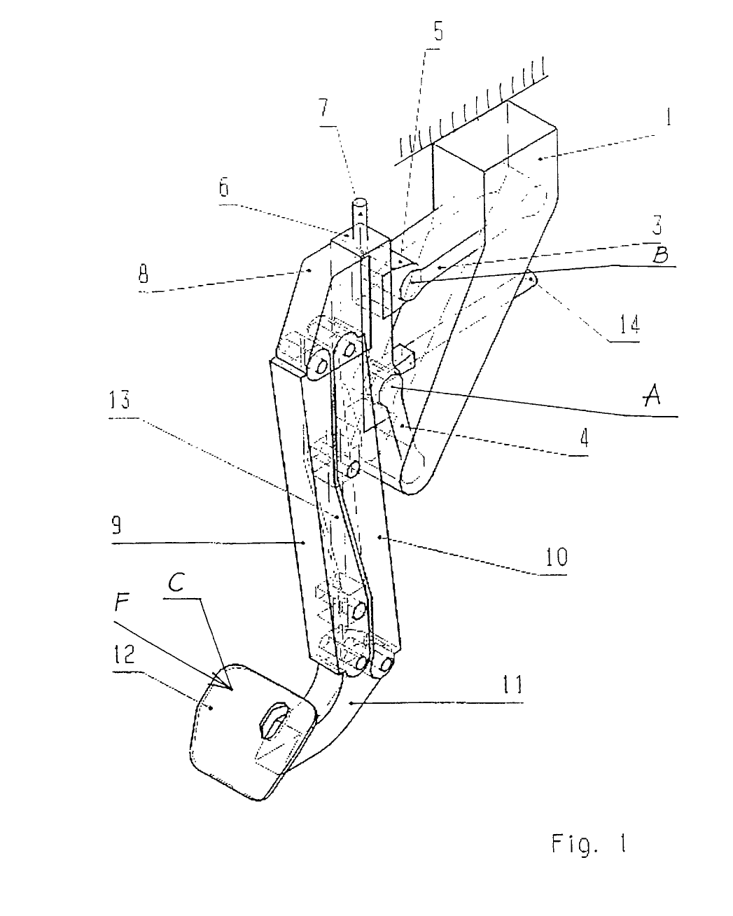

FIG. 1 shows a perspective illustration of the pedal mechanism in basic position;

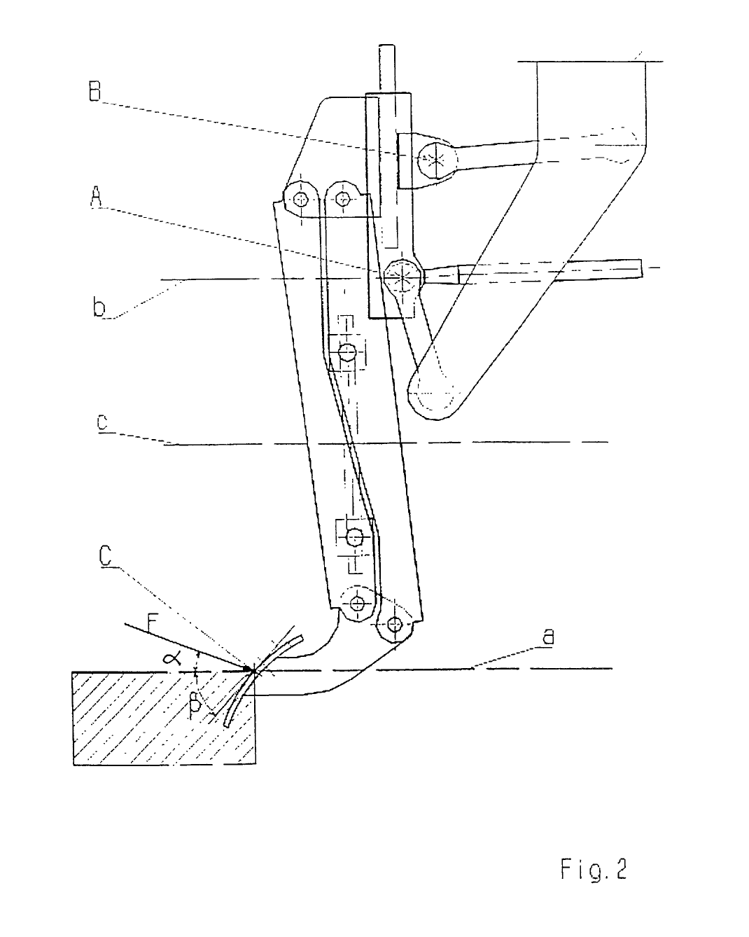

FIG. 2 shows a diagrammatic side view of the pedal mechanism;

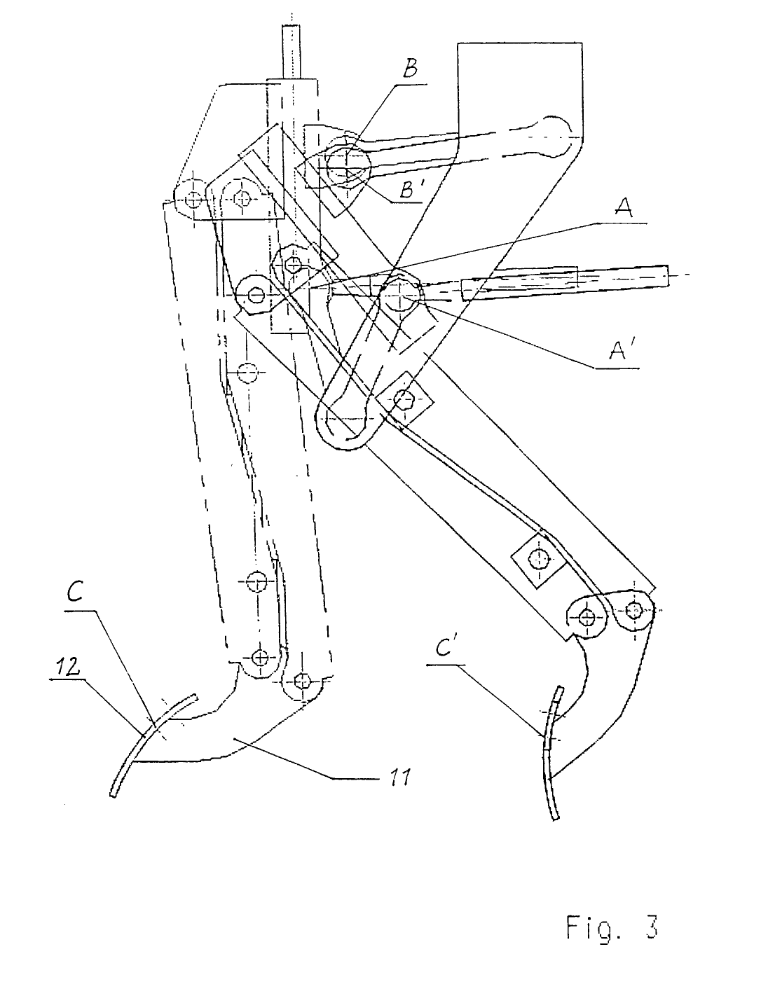

FIG. 3 shows a side view of the pedal mechanism in basic position and after operation;

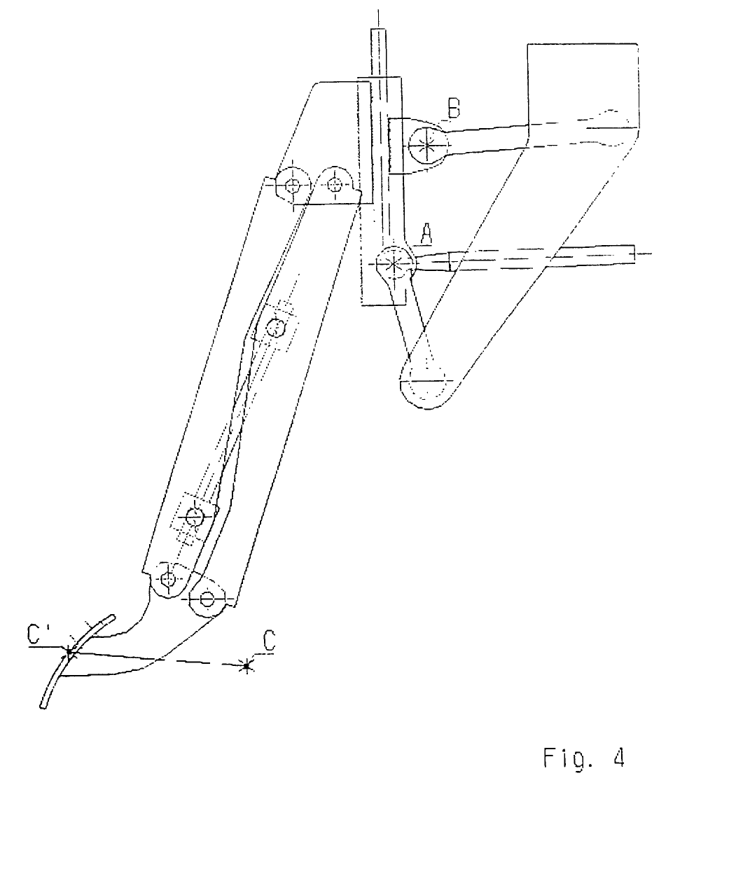

FIG. 4 shows the pedal mechanism after adjustment in the negative X direction (−X);

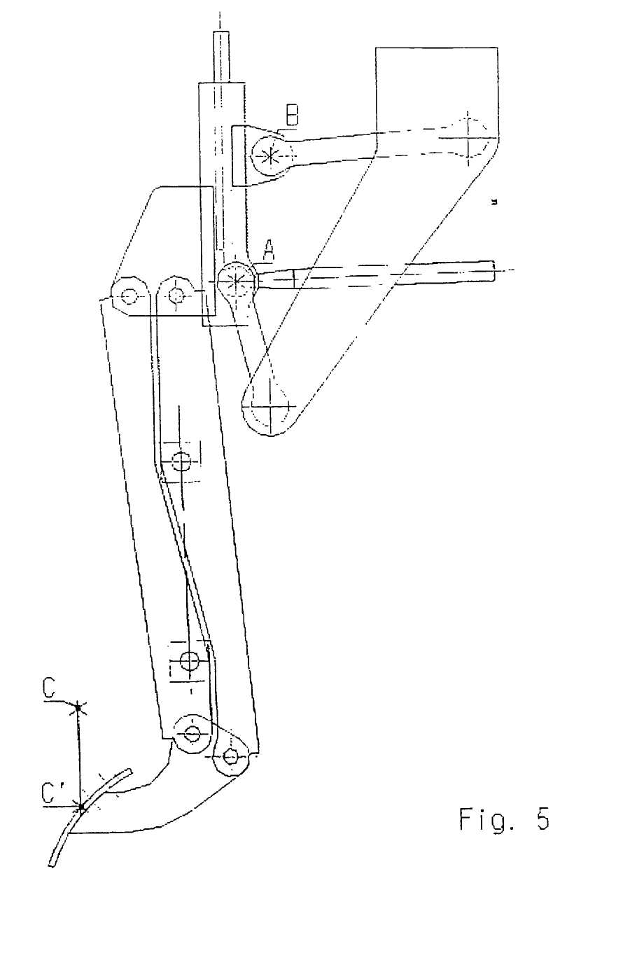

FIG. 5 shows a side view of the pedal mechanism in a position adjusted in the negative Z direction (−Z) in relation to the basic position;

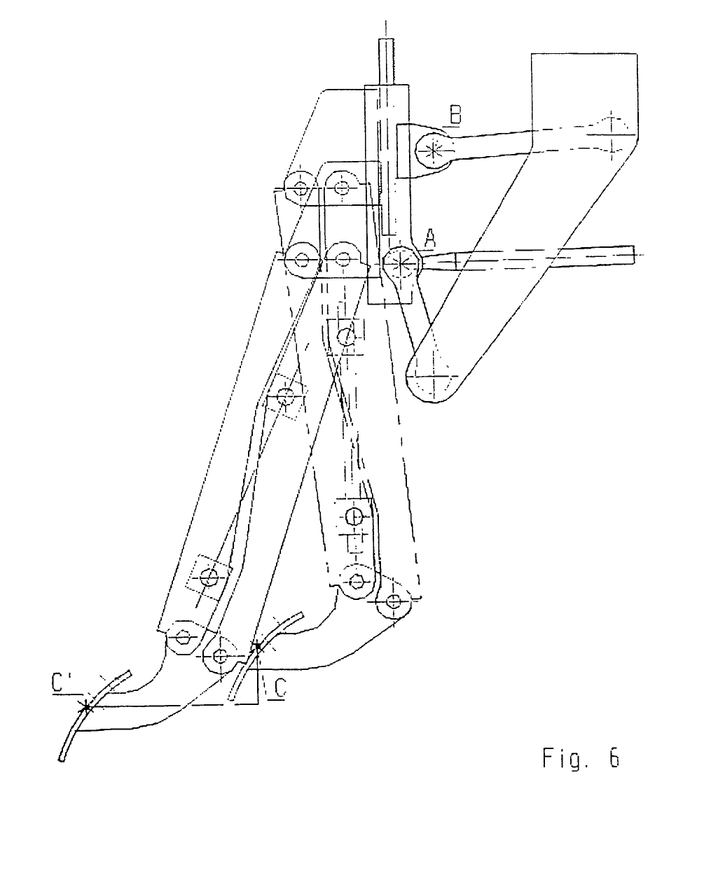

FIG. 6 shows a side view of the pedal mechanism in a position adjusted in −X and −Z in relation to the basic position;

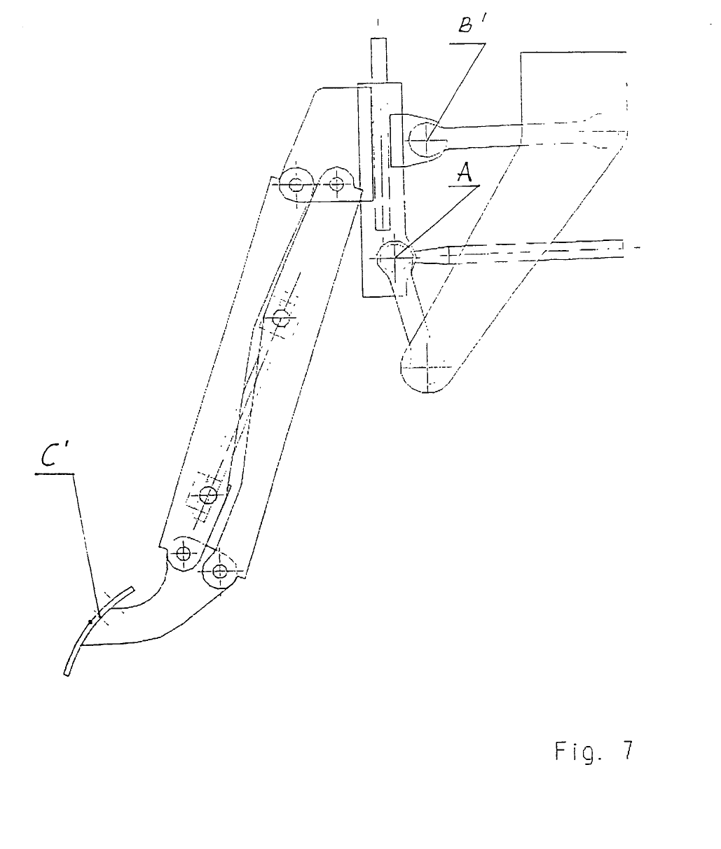

FIG. 7 shows the pedal mechanism adjusted in −X with compensation of the transmission ratio;

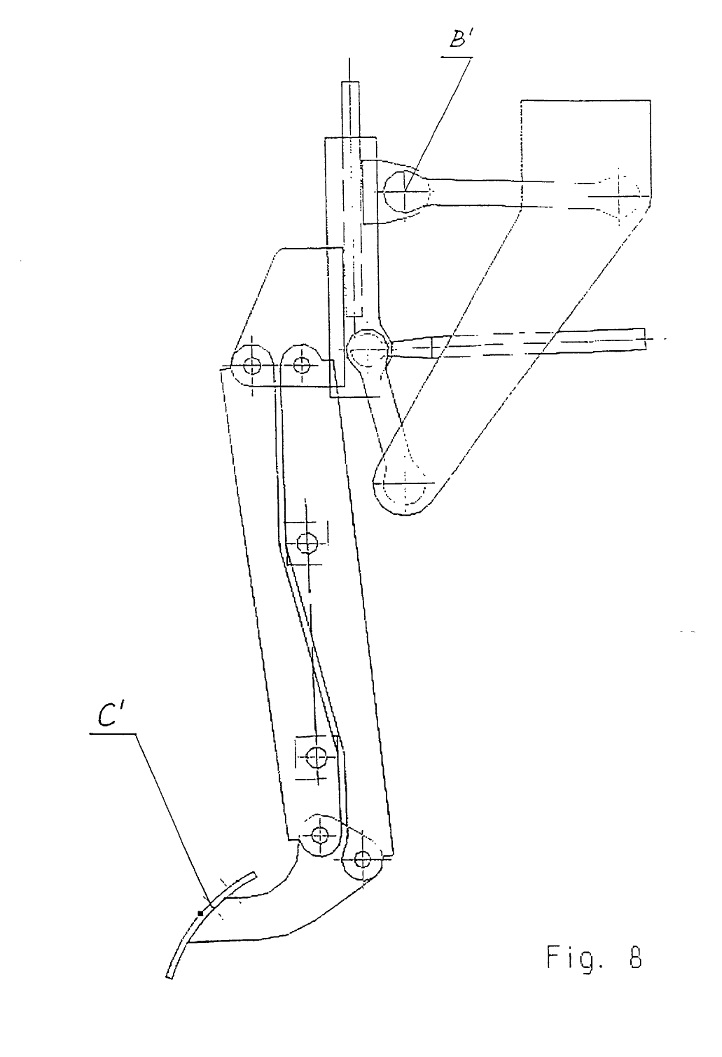

FIG. 8 shows the pedal mechanism adjusted in −Z with compensation of the lever transmission ratio;

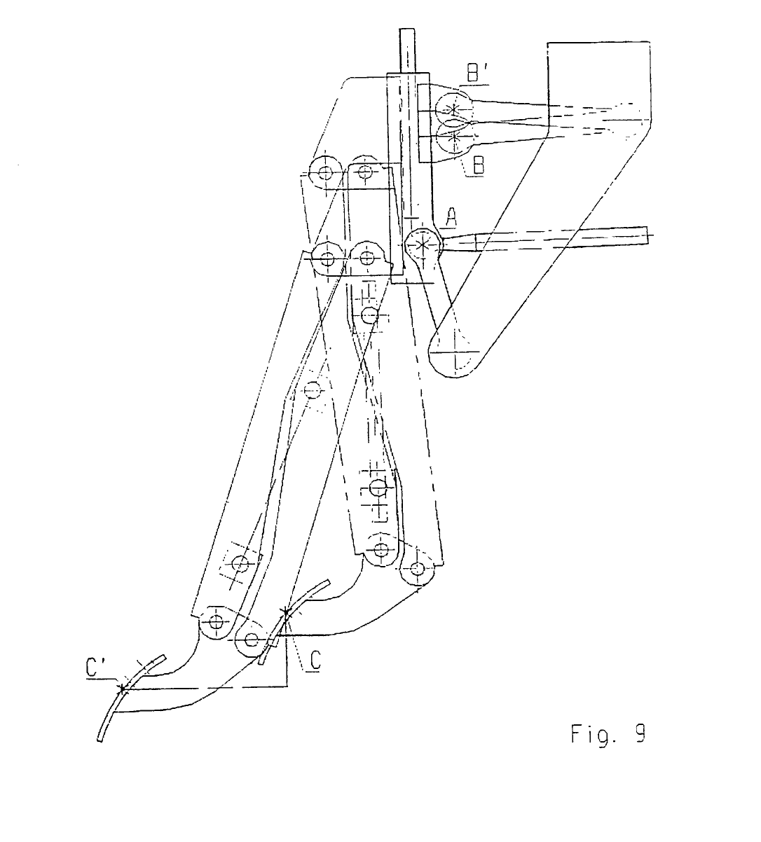

FIG. 9 shows the pedal mechanism adjusted in −X and −Z with compensation of the transmission ratio, and

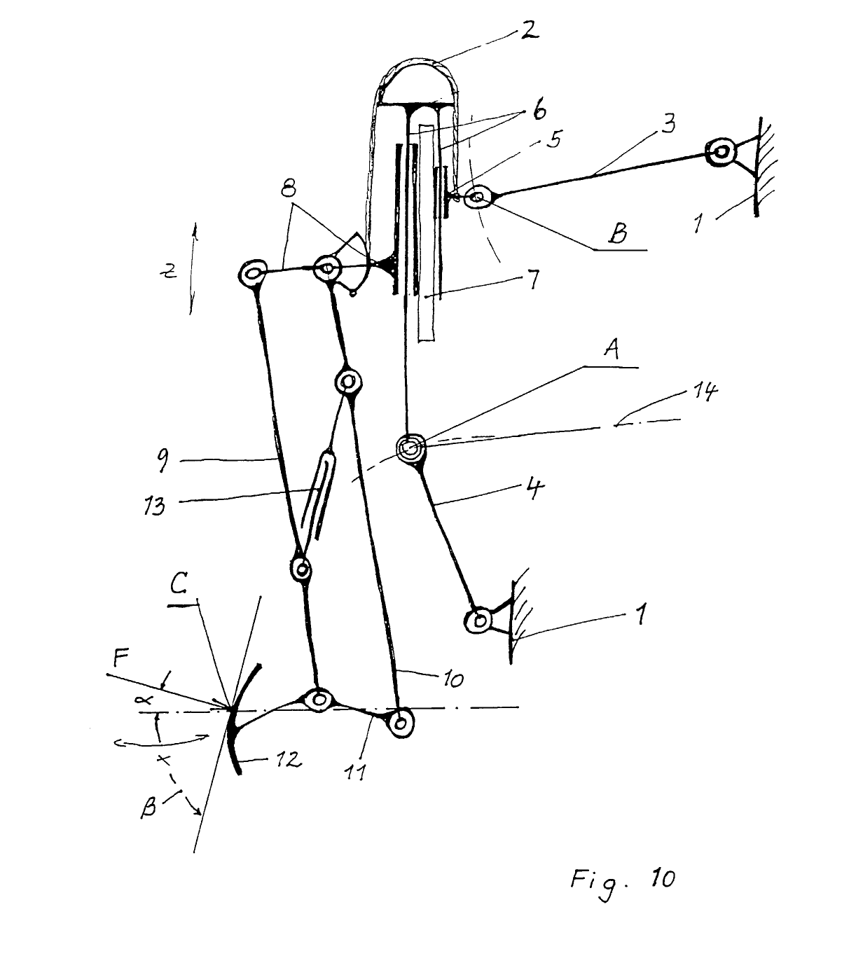

FIG. 10 shows a schematic diagram of a pedal mounting.

In FIG. 1, the individual parts of the pedal mechanism shown as an illustrative embodiment can also be seen clearly in their functional interaction. The stationary bearing block 1 with the fixed bearings of the main bearing connecting rod and of the pushrod bearing connecting rod, the main bearing connecting rod 3 mounted rotatably at one end in said block, and the pushrod bearing connecting rod 4 can be seen clearly, the other end of the main bearing connecting rod 3 being mounted rotatably in a main bearing B designed in a sliding block 5, and the other, free end of the pushrod bearing connecting rod 4 being mounted rotatably in a pushrod bearing A designed on the guide rocker 6. The sliding block 5 and the holding carriage 8 are mounted displaceably in the Z direction on the guide rocker 6. Arranged in the guide rocker 6 is a threaded spindle 7 which is in engagement with a toothing of the holding carriage 8 and of the sliding block 5.

Articulated approximately parallel to one another from the holding carriage 8 mounted displaceably on the guide rocker 6 are two legs 9, 10 which are articulated by their other end on the holding link 11. The holding carriage 8, the two legs 9, 10 and the holding link 11 form a four-bar parallelogram. The footplate 12 is attached to the holding link 11. A nut is in each case mounted by cardan means in the two legs 9, 10, the nuts being passed through by a threaded rod 13. A pushrod 14, for example for a brake booster, is mounted rotatably in the pushrod bearing A, which forms the output point of the pedal mechanism.

In FIG. 2, in which a side view of the pedal mechanism in a basic position is illustrated diagrammatically, the main bearing B, the force introduction point or pressure point C and the output point A, which is located in the pushrod bearing, are marked individually. The operating force F forms the force introduction angle α to the horizontal. The footplate has a setting angle β in relation to the horizontal. Starting from the pressure point C, a rectangular area is illustrated by hatching, which outlines the coordinates of the envisaged adjustability of the pedal mechanism in the −Z and the −X direction. Also drawn in are horizontal paths a, b and c, which indicate movement paths of the pressure point C (a), of the pushrod bearing (b) and of the footplate with a different connecting rod geometry (c).

In FIG. 3, the broken lines illustrate the pedal mechanism in basic position, and the solid lines illustrate the pedal mechanism after operation in the X direction. It is clearly visible that, on operation, the footplate 12 has moved approximately on a horizontal path, and that the holding link, with the footplate attached thereto, has been pivoted counterclockwise slightly. It can furthermore be seen that the main bearing has been displaced slightly in the −Z direction on a pivoting path about the articulation of the main bearing connecting rod on the bearing block in −Z. The pushrod bearing A has been pivoted on a virtually horizontal path in the X direction on a pivoting path about the articulation of the pushrod bearing connecting rod on the bearing block in the X direction.

FIG. 4 illustrates the pedal bearing in a position adjusted in −X from C to C′, and FIG. 5 shows it in a position adjusted from C to C′ after adjustment in the −Z direction. FIG. 6 illustrates the position of the pedal mechanism after adjustment in −X and −Z from C to C′. In all three illustrations in FIG. 4 to FIG. 6, the position after adjustment is shown without compensation of the lever transmission ratio. The lever transmission ratio ü is defined by the ratio of the lever lengths CB/BA. Compensation of the lever transmission ratio ü results in this lever transmission ratio being retained after adjustment also.

The operational interrelation for compensation of the lever transmission ratio is explained with reference to the illustration in FIG. 7 to FIG. 9.

It can be seen in FIG. 7 that, on adjustment of the footplate toward −X, the main bearing B is displaced upward slightly. After an adjustment in −Z, as illustrated in FIG. 8, the main bearing B is displaced upward still more clearly. This displacement of the main bearing B to B′ to compensate the lever transmission ratio ü on adjustment of the footplate in −X and −Z is very clear from the double illustration in FIG. 9. As the lever CB is lengthened when C is adjusted to C′, the lever length AB must also be lengthened, in order for the lever length ratio C′B′/B′A to be the same as CB/BA. As the height of the output point A in the pushrod bearing is not to be changed, the main bearing B must be displaced to B′ to compensate the lever transmission ratio. This results in the requirement that the difference of the lever arm length from C′ to B′ in comparison with CB changes in relation to the difference of AB′ in comparison with AB proportionally to the lever transmission ratio CB/BA.

The adjusting arrangement is designed in such a manner that no adjustment is possible during operation of the pedal mechanism. After adjustment, the structure from footplate to sliding block, and thus from C to B, is to be regarded as rigid.

FIG. 10 shows a schematic diagram of the pedal mechanism in an illustration which is to a great extent comparable with FIG. 1. One difference between the illustrations in FIG. 1 and FIG. 10 concerns the compensation of the transmission ratio on adjustment in the Z direction, which is carried out in FIG. 1 by means of a threaded rod 7 with different pitches of the oppositely directed threaded portions and in FIG. 10 by means of a cable pull 2 with deflection and a mechanism (not shown), for example a pulley block.

List of References

1 fixed support, bearing block

2 cable pull

3 main bearing connecting rod

4 pushrod bearing connecting rod

5 sliding block

6 guide rocker

7 threaded rod, Z adjustment

8 holding carriage

9 leg

10 leg

11 holding link

12 footplate

13 threaded rod, X adjustment

14 pushrod

A output point, pushrod bearing

B main bearing

C pressure point, force introduction point

F operating force

α force introduction angle on the footplate

β setting angle of the footplate

1. A pedal mechanism, having a four-bar parallelogram which is formed from an upper holding part (8), a lower holding link (11) with footplate (12) attached thereto, and two legs (9, 10) which are arranged roughly parallel and are in each case mounted rotatably by one end on the upper holding part (8) and by the other end on the lower holding link (11), the pedal mechanism being pivotable about a main bearing (B), and an adjusting device for adjustment of the footplate (11), predominantly in the X direction, being provided, characterized in that the upper holding part (8) and a sliding block (5) with a main bearing (B) designed thereon are mounted displaceably and adjustably in the Z direction, and a length-adjustable strut (13) is provided between the legs (9, 10), which is mounted rotatably in these at both ends.

2. The pedal mechanism as claimed in claim 1, characterized in that the upper holding part (8) and the sliding block (5) are mounted on a guide rocker (6), and a main bearing connecting rod (3) and a pushrod bearing connecting rod (4) are provided, one end of which is in each case mounted rotatably on a stationary bearing block (1) and the other, free end of which is mounted rotatably in the main bearing (B) or in a pushrod bearing (A), the pushrod bearing (A) being designed on the guide rocker (6).

3. The pedal mechanism as claimed in claim 1 or 2, characterized in that the adjusting device for the footplate (12) is formed by a nut being mounted by cardan means on each of the two legs (9, 10) and a threaded rod (13) passing through the two nuts, the threaded rod (13) having an oppositely directed thread in each case in the engagement region with the two nuts.

4. The pedal mechanism as claimed in claim 2 or 3, characterized in that a threaded rod (7) integrated in the guide rocker (6) is arranged in such a manner that it is in engagement with toothings of the upper holding part (8) and of the sliding block (5), the threaded rod (7) having an oppositely directed thread in each case in the engagement region with the two parts.

5. The pedal mechanism as claimed in claim 3 or 4, characterized in that the pitches of the right-hand thread and of the left-hand thread are different and the ratio they bear to one another is the transmission ratio ü of the lever arms between a pressure point (C) on the footplate (12) and the main bearing (B) and between the main bearing (B) and the pushrod bearing (A).

6. The pedal mechanism as claimed in claim 1, characterized in that the upper holding part (8) and the sliding block (5) are connected via a cable pull (2) and a deflection mechanism.

7. The pedal mechanism as claimed in claim 1, characterized in that the parts of the four-bar parallelogram are configured in such a manner that the adjustment of the pedal in the X direction runs along a horizontal path.

8. The pedal mechanism as claimed in claim 1, characterized in that the rear leg (10) in the X direction is slightly longer than the leg (9), both legs being articulated on a level on the upper holding part (8).

9. The pedal mechanism as claimed in claim 2, characterized in that the lengths of the two connecting rods (3, 4) of the kinematic linkage are configured in coordination with the bearing block (1) in such a manner that the line of action of the pressure point C runs in a predetermined height position and on a largely horizontal path on operation.

10. The pedal mechanism as claimed in claim 3, characterized in that at least one of the threaded rods (7, 13) for the adjustment in the X direction and the Z direction is motor-driven.

11. The pedal mechanism as claimed in claim 1, characterized in that a footrest is provided, which can be adjusted corresponding to the adjustment of the footplate.
